(19) United States
(12) Patent Application Publication
(10) Pub. No.: US 2018/0350089 A1
(43) Pub. Date: Dec. 6, 2018

(54) SITE MEASURING DEVICE AND ASCERTAINING A GEOMETRIC MEASUREMENT VALUE

(71) Applicant: Testo SE & Co. KGaA, Lenzkirch (DE)

(72) Inventors: Jan-Friso Evers-Senne, Titisee-Neustadt (DE); Pablo Bueno-Plaza, Freiburg (DE); Hellen Altendorf, Kirchzarten (DE); Tobias Adenauer, Merzhausen (DE); Jens Einighammer, Freiburg (DE)

(73) Assignee: Testo SE & Co. KGaA, Lenzkirch (DE)

(21) Appl. No.: 16/001,355

(22) Filed: Jun. 6, 2018

(30) Foreign Application Priority Data
Jun. 6, 2017 (DE) 102017112443.8

(51) Int. Cl. G06T 7/60; G06T 7/13; G06T 17/00; G06T 7/80; G06T 3/00; H04N 5/225

(52) U.S. Cl. CPC G06T 7/60; G06T 7/13; G06T 17/00; G06T 2207/30184; G06T 3/0018; H04N 5/2254; G06T 7/80

(57) ABSTRACT

A site measuring device (1) for ascertaining a geometric measurement value, having an image capturing device with a fisheye lens (5) and a planar image sensor (6) for capturing an image of the lens (5), and an image processor.

### INCORPORATION BY REFERENCE

The following documents are incorporated herein by reference as if fully set forth: German Patent Application No. 10 2017 112 443.8, filed Jun. 6, 2017.

### BACKGROUND

The invention relates to a site measuring device, having an image capturing device with a lens and a planar image sensor for capturing an image of the lens, and an image processor set up for ascertaining a geometric measurement value.

Ascertaining a geometric measurement value is effected here for example in accordance with a photogrammetric method. The image capturing device can here be a commercially available digital camera, for example. To ensure that geometric sizes in the recorded image are determinable, the image capturing device must be calibrated.

The site measuring device according to the invention serves in particular for measuring buildings and building facades. Therefore, mapping of a planar object onto a planar image sensor is affected. To this end, generally normal lenses are used that allow distortion-free mapping (gnomonic mapping). Distortion-free means here that straight lines of the object are also straight in the image. Mapping is effected in accordance with the generalized form r=f tan θ.

However, due to the camera pose and/or to aberrations of the lens, the image may become more or less distorted. If the image plane of the image sensor is not aligned parallel to the object plane, trapezoidal distortions (converging verticals) occur, for example. Since a lens element cannot be perfect, further distortions also occur, for example barrel or pincushion distortions, chromatic aberrations and many other distortions. These distortions must first be corrected before the image is usable for determining the measurement variables.

Moreover, the mapping type of the object causes objects or features to be presented in strongly distorted form at the image periphery. As a result, the accuracy for measurements strongly decreases in the direction of the image periphery.

Another disadvantage in the prior art is that building facades are usually not capturable with one image. For this reason, a plurality of individual images are recorded in practice and processed individually or joined together to form a large image. In order to reduce the number of the necessary individual images, the use of wide-angle lenses would be advantageous. However, the distortions strongly increase as the focal length of the lens falls. In order to obtain the required accuracy for the measurement values, it is therefore necessary to dispense with wide angles which are too encompassing and evaluate a plurality of individual images. The time expenditure for measuring a building facade is therefore very great.

### SUMMARY

It is therefore an object of the invention to provide a site measuring device of the type mentioned previously, with which the outlay for ascertaining a geometric measurement value is lower and the accuracy is greater.

This object is achieved according by a site measuring device having one or more features of the invention. The site measuring device is here in particular characterized in that the lens of the image capturing device has a non-gnomonic mapping function, as a result of which the distortions are lower toward the image periphery. The site measuring device according to the invention therefore has a homogeneous accuracy over the entire image.

In an advantageous embodiment of the invention, the lens defines a projection center. As a result, a central projection is implemented. This has the advantage that the accuracy toward the image periphery is greater with respect to the prior art.

It is expedient in particular if the lens is a fisheye lens, because greater image angles are attainable thereby.

In a particularly expedient embodiment, the lens has an equidistant mapping function. Mapping is here linearly dependent on the angle and in particular contains no trigonometric component. In contrast to a perspective mapping function, in which mapping is dependent on the tangent of the angle, image angles of greater than 180° are also possible therewith.

In an advantageous embodiment of the invention, the image angle of the lens is greater than 90°, in particular greater than 180°. Consequently, a large object is capturable with fewer individual images.

In an advantageous embodiment of the invention, the mapping function defines a linear dependence between a radius R and the angle θ. This represents the ideal embodiment of an equidistant mapping function. This has the advantage that the mapping function is simple.

In strictly equidistant mapping, the footprint of a pixel increases toward the image periphery, as a result of which measurement becomes more difficult. In an advantageous further development of the invention, the mapping function is describable by a polynomial distortion model.

The advantage here is that the distortion can preferably be selected such that, in the image periphery region, the footprint of a pixel on the object to be measured does not become larger. This is preferably achieved by the lens being embodied such that it distorts more strongly in the periphery region. The mapping function therefore changes toward the periphery region such that the mapping function itself is a function of the angle.

The mapping function here has, in addition to the linear dependence on the angle, higher-power dependences. The mapping function of the lens therefore has at least one additional polynomial element of a higher, in particular the third or higher, degree. Due to the symmetry of the mapping, the polynomial preferably only has the polynomial elements with odd powers.

It can also be expedient if the mapping function of the lens additionally has at least one non-linear dependence of the angle θ, in particular a trigonometric function.

Due to manufacturing tolerances, deviations of the mapping functions in the lenses can occur. It is therefore advantageous if the mapping function of the lens is ascertainable by way of a calibration with a reference object. The advantage here is that the mapping function for each lens is accurately ascertainable, as a result of which the accuracy of the measurements increases.

The mapping function is preferably storable, or stored, in the image processor after the calibration. In this way, the mapping function can be accessed for calculations.

In an advantageous embodiment of the invention, the image processor has a feature finder for detecting point and/or edge features in the recorded images, wherein the feature finder, for edge detection, approximates lines, which have been detected in the recorded images and transformed with the mapping function, to a straight line.

As opposed to the prior art, in the embodiment according to the invention, the recorded images are not transformed or distortion-compensated with the mapping function, and no search is performed for the edge features in the transformed images. Instead, a search is performed in the recorded images for line features which are then approximated to straight lines or other known geometries, such as arcs, using the mapping function. As a result, the accuracy of the edge detection is significantly improved. Since the transformations are effected in each case only locally for one line, the calculation is able to be performed significantly more simply and quickly. Furthermore, the accuracy is improved thereby, because after edge detection has been performed, the further processing steps are carried out on the recorded image. That means that the line which has been identified as an edge or another geometry is merely marked as such in the recorded image. All further calculations are then performed using the line in the recorded image.

In this way, it is possible to establish from a plurality of images a three-dimensional image or model of a recorded object.

To fit a further image into an existing model, it is advantageous if the image processor has a feature finder for detecting point and/or edge features in the recorded images, wherein the feature finder uses edges which have been transformed with the mapping function for edge detection in a recorded image. That means that an edge which is already present in the model is able to be transformed with the mapping function in order to identify it as a line in the recorded image. In this way, what is referred to as re-matching of known features in new images is possible, without an entire image being transformed.

What is fundamental here is that in each case only features are transformed with the mapping function, and not entire images. This makes it possible to perform the calculation more easily and faster. To this end, such an image processor can also be embodied to be less efficient, such that integration even in hand-held devices is more easily possible.

In an advantageous embodiment of the invention, the image capturing device and the image processor are integrated in each case or together in a portable device. Particularly advantageous is an integration in a common portable device. Such a device can additionally have a screen for presenting images and other information. For example, an image from the image capturing device can be presentable on the screen for recording images.

In particular if the image capturing device and the image processor are embodied in separate devices, it is expedient if the image capturing device is embodied for transferring the image data to the image processor. To this end, a wire-bound or wire-free interface may be present, for example. Particularly advantageous here is a radio interface with which the image data are transferable even over a greater distance.

In an advantageous embodiment, the image sensor is arranged perpendicular to the optical axis of the lens. As a result, a simpler alignment of the image plane of the image sensor with respect to a planar object is possible.

The method according to the invention for measuring a geometric variable with a site measuring device having an image capturing device with a lens that defines a projection center, a planar image sensor for capturing an image of the lens, and an image processor which is set up for establishing a three-dimensional model from a plurality of recorded images is characterized in particular in that:

in an image recording step, a plurality of non-perspective images of an object are recorded with the image recording device,

in an edge detection step, lines are detected in the recorded images and said lines are transformed with the mapping function of the lens, wherein the lines which can be approximated as a straight line are registered as an edge feature,

in a modelling step, a three-dimensional model is calculated from lines which are assigned to the registered edge features,

in that the geometric variable is determined in the three-dimensional model.

In a development, the detected lines are not only approximated to straight edges, but any desired known geometries, such as arcs.

It is advantageous here for the edge detection to be performed in the recorded image and for only the detected lines to be transformed with the mapping function. In this way, significantly faster calculation is possible. Moreover, the accuracy of the three-dimensional model is also greater, because it is established from the recorded images. For this reason, the measurement values which are ascertained in this model are also more accurate.

It is particularly advantageous here if, in a calibration step, the mapping function of the lens is determined, wherein a model is calculated from a plurality of images of a reference object and, from the deviations of the model with respect to a reference model, the mapping function is determined.

In an expedient development of the invention, in a bundle adjustment step, not only the actual bundle adjustment is performed but also optimization of camera parameters. These camera parameters can be, for example, dependent on the temperature of the environment or other environmental influences.

This optimization can include for example corrections of the mapping function.

### BRIEF DESCRIPTION OF THE DRAWINGS

The invention is described in more detail below with reference to the accompanying drawings.

In the figures:

FIG. 1 shows a front view of a site measuring device according to the invention,

FIG. 2 shows a side view of the site measuring device of FIG. 1,

FIG. 3 shows a diagram of the mapping function of the fisheye according to the invention as compared to various lenses,

FIG. 4 shows a diagram of the relative distortion of a fisheye lens according to the invention as compared to an ideal fisheye lens,

FIG. 5 shows a diagram showing the footprint of various lenses with different mapping functions,

FIG. 6 shows a schematic diagram for illustrating the feature finder,

FIG. 7 shows a schematic diagram of the feature finding in a plurality of images.

### DETAILED DESCRIPTION OF THE PREFERRED EMBODIMENTS

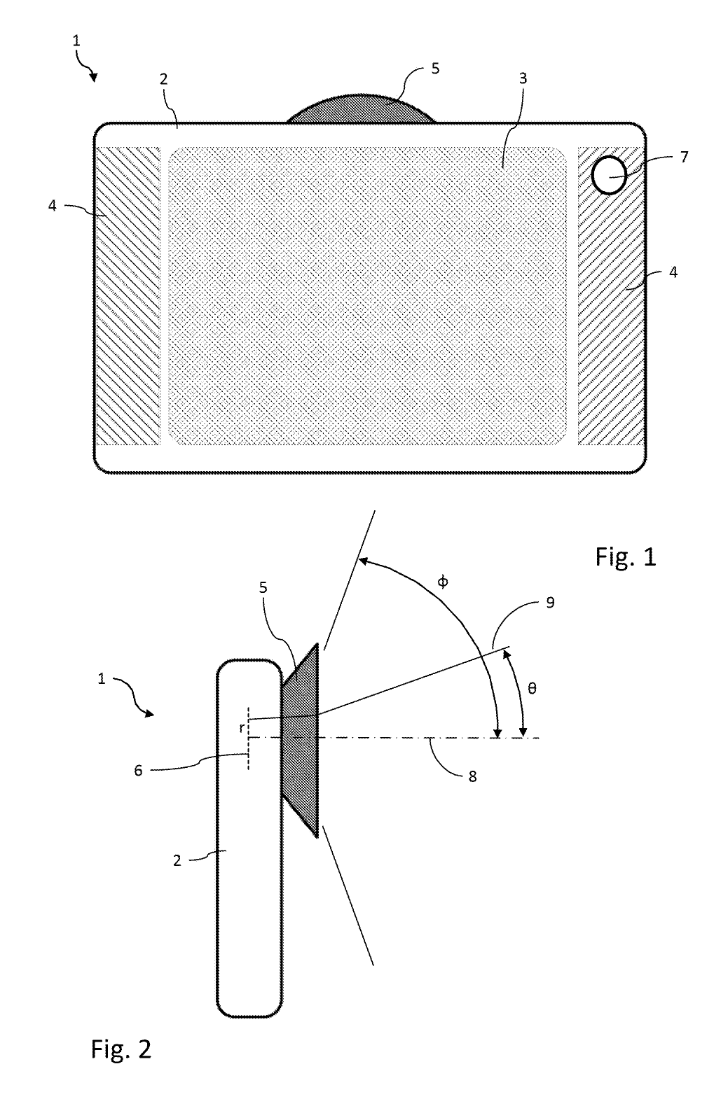

FIG. 1 shows a schematic illustration of a site measuring device 1 according to the invention. The site measuring device 1 has a substantially cuboid housing 2. The site measuring device 1 has a screen 3, on which information is graphically presentable. On both sides next to the screen 3, handles 4 are arranged, with which it is possible to securely handle the site measuring device 1.

In the example, a fisheye lens 5 according to the invention is arranged on the side of the housing 2 that is opposite the screen 3. Located inside the site measuring device 1 is a planar image sensor 6 for capturing an image produced by the lens 5.

For operation purposes, the site measuring device can be equipped with a touch-sensitive screen. In the example, the site measuring device additionally has a trigger 7, with which the recording of an image is triggerable.

The side view in FIG. 2 shows that the fisheye lens 5 in the example projects beyond the housing 2 and the optical axis 8 of the lens 5 is aligned substantially perpendicular to the image sensor 6 that is arranged inside the housing 2. The fisheye lens in the example has an angular aperture φ of 70°. The angle of view is therefore 140°. Other lenses with other angles of view are of course also possible.

The fisheye lens 5 has special properties that make the site measuring device 1 according to the invention possible in the first place. For example, the lens 5 has a specifically adapted mapping function which is deliberately distorted, proceeding from an ideal equidistant mapping function, in the periphery region in the direction of gnomonic mapping.

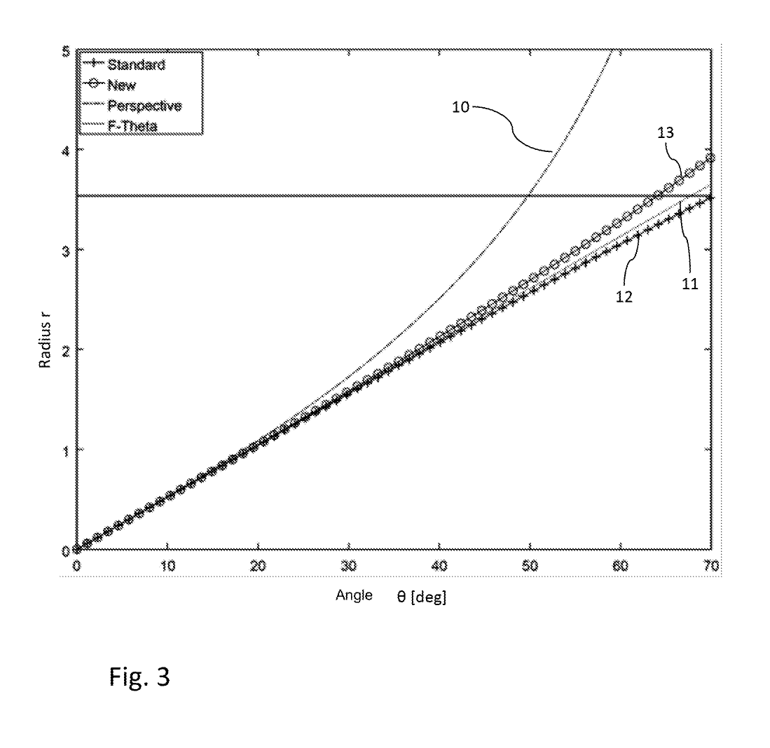

FIG. 3 illustrates a graph of the mapping function of the fisheye lens 5 according to the invention as compared to other mapping functions. In the graph, the x-axis shows the angle of incidence θ of a light ray 9 with respect to the optical axis 8 of the lens 5. The y-axis shows the distance r of the image of the light ray on the image sensor 6 from the optical axis 8.

The dot-dashed curve 10 shows the mapping function of a perspective lens with gnomonic mapping. The mapping function can be described by r=f tan θ. Due to the tangent component, objects at the image periphery are presented in strongly magnified fashion. In addition, the mapping function is consequently limited to a maximum angular aperture of less than 90°, wherein even at angular apertures from 60° the distortion in the periphery region is so great that the accuracy strongly decreases here.

The dotted curve 11 corresponds to an ideal equidistant mapping function, which can be described by r=fθ. This mapping function in this diagram is a straight line.

The curve 12 with the plus symbols corresponds to a real or normal equidistant mapping function. This curve falls under the ideal mapping function 11, which is why a distortion occurs toward the periphery region. Objects in the periphery region are compressed as a result, which is a disadvantage for the application according to the invention.

The fisheye lens 5 according to the invention therefore has an adapted, equidistant mapping function, shown in the image by the curve 13 with the circles. According to the invention, the mapping function in the periphery region is changed in the direction of a perspective mapping such that objects are rather stretched toward the periphery region. The mapping behavior in the periphery region is therefore exactly inverse, as in the real mapping function 12. In particular when mapping planar objects, the accuracy consequently increases in the periphery region.

The mapping function according to the invention can be described by a polynomial distortion model. The mapping function therefore in particular also has higher-order terms. A mapping function can therefore be described as follows:

r=aθ+bθ̂3+cθ̂5 . . .

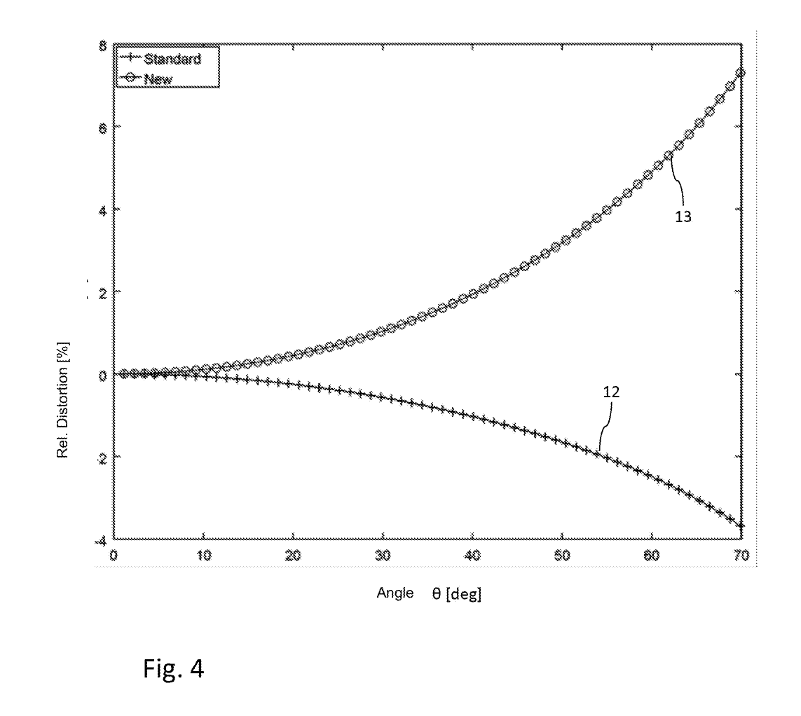

To clearly illustrate the improvement in accuracy, FIG. 4 shows the relative distortion of different mapping functions in dependence on the angle of incidence θ. As can be seen here again, the fisheye lens 5 according to the invention has a distortion in the periphery region which is the opposite of that of a normal fisheye lens.

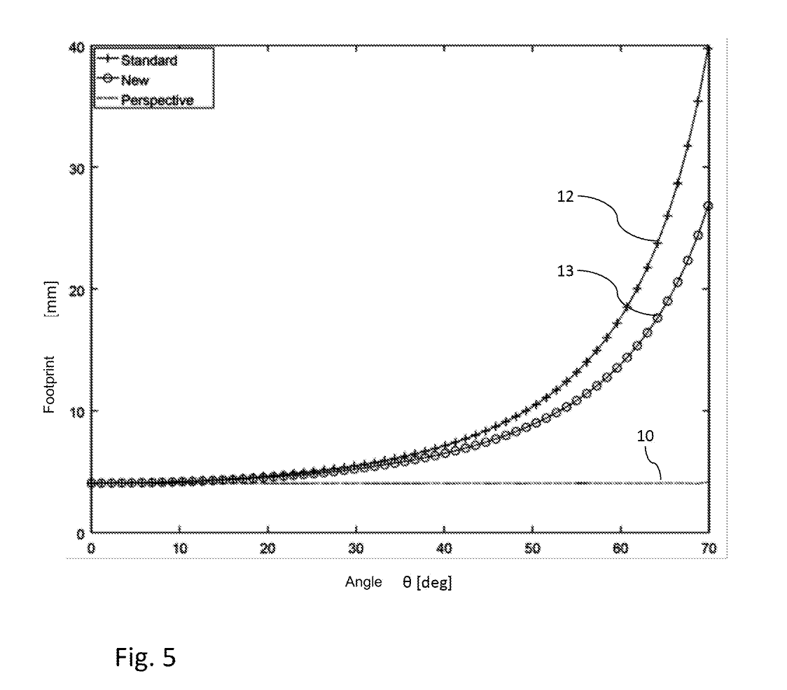

Due to the distortion that is adapted in accordance with the invention in the periphery region, the footprint of a mapped object of the fisheye lens according to the invention is also lower with respect to a normal fisheye lens. The footprint of the lens according to the invention is shown in FIG. 5 as compared to a normal fisheye and a perspective lens. The symbols of the curves in FIGS. 3 to 5 are in each case identical for the corresponding lenses and mapping functions.

The fisheye lens 5 according to the invention is specifically developed and adapted for such a mapping function. In particular, the change in mapping function in the periphery region toward a rather perspective distortion overall makes possible a significantly more accurate determination of geometric measurement variables with the site measuring device 1 according to the invention.

In addition to the specially adapted fisheye lens 5, specially adapted image processing according to the invention in the site measuring device 1 according to the invention also makes a crucial contribution to the high measurement accuracy.

A site measuring device 1 according to the invention has an image capturing device with a fisheye lens 5, which has an adapted mapping function as described above, a planar image sensor 6 for capturing an image of the lens 5, and an image processor for determining a geometric variable within the recorded images.

Determining a geometric variable, such as the length of an object located in the image, is sufficiently known with the aid of photogrammetric methods.

A particularly advantageous method is establishing a three-dimensional model of the mapped object from a plurality of individual images. In this way, it is possible to determine all dimensions within the model on the basis of the model.

Establishing a three-dimensional model from a plurality of recorded images is likewise sufficiently known in the prior art. In principle, distinctive points or edges which are identifiable in the individual images are to this end detected in the images. Due to the known location of the image recording apparatus with respect to the object and the different recording poses, the points or lines can be three-dimensionally correlated with respect to one another.

The edge detection generally presupposes rectilinear edges. In an image recording apparatus with a perspective lens, rectilinear edges are generally maintained. Any occurring distortions are compensated for according to the prior art after the image recording. This can be done for example by calculation with a correction function. For this reason, the entire image must always be corrected first. Complicated and/or high-performance image processing is necessary herefor. In addition, the edge detection is then inaccurate because it is done only on the corrected image.

The recorded images in the site measuring device according to the invention, however, are distorted by the fisheye lens such that in particular rectilinear edges appear curved in the image. Known methods now make provision for the recorded images to be initially transformed completely with the mapping function such that straight lines in the image again appear rectilinear.

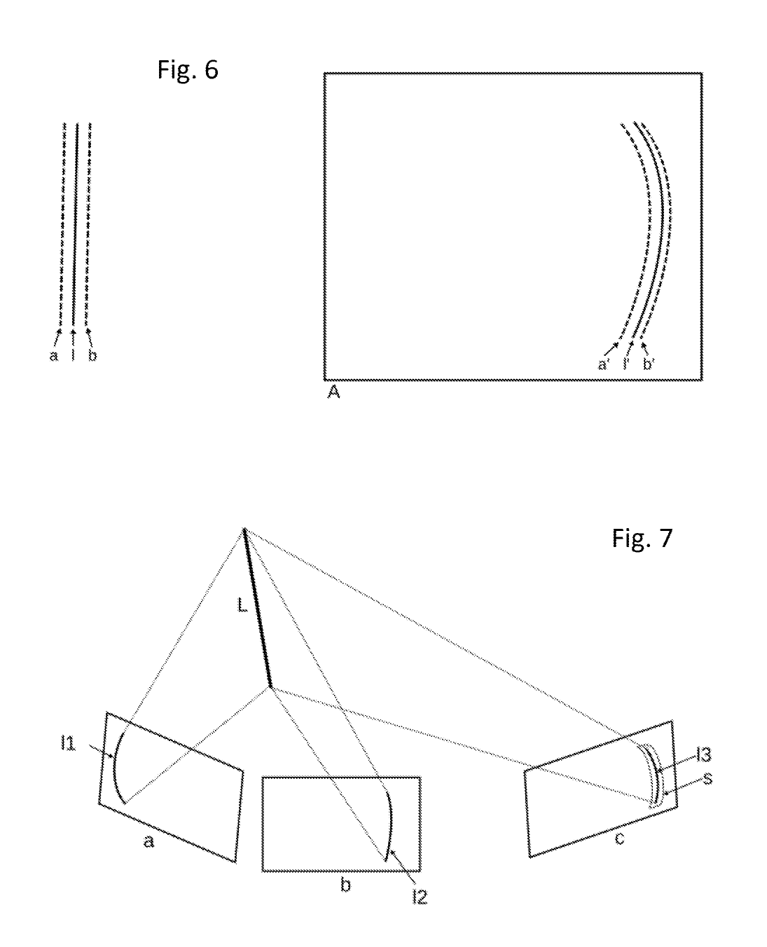

The invention takes another route here, however, wherein the method according to the invention will be explained in more detail with respect to FIG. 6.

First, in an image recording step, a plurality of non-perspective images of an object are recorded with the image recording device.

In an edge detection step, the lines l′, which may be arbitrarily curved, are then detected in a recorded image A. These detected lines l′ are locally transformed with the known mapping function. A check is performed here as to whether the transformed line l′ corresponds to a rectilinear edge l or is able to be approximated to a rectilinear edge l. Instead of rectilinear edges, other known geometries, such as arcs, can be used. What is important is that the geometry in the transformed region is detectable. The advantage here is that initially a transformation only for a few image regions must be performed. This can be done very quickly.

The lines l, which can be approximated as straight lines, are registered as an edge feature and stored in a buffer for further use for establishing a three-dimensional model.

Next, a region which is delimited by two parallel structures a and b on both sides of the line l is defined around the detected structure l. This region is now back-transformed to the recorded image using the mapping function. The delimitation lines a and b become lines a′ and b′, which in the recorded image delimit a region around the line l′.

Within this region in the recorded image, descriptors can now be identified or found, which can be used for the reliable identification of features in other images.

In a modelling step, a three-dimensional model is now calculated from the non-transformed lines l′, which correspond to the registered edge features. It is possible here to follow a known method.

The requirement here is to use the recorded image data to determine the three-dimensional model and not the transformed straight lines. This image data have a significantly higher accuracy and information density than the transformed image regions. For this reason, the calculated model is significantly more accurate. In particular in connection with the mapping function of the fisheye lens that has been adapted in accordance with the invention, the accuracy especially in the periphery regions is significantly greater than in the prior art.

As soon as the three-dimensional model has been established, any desired geometric variable in the model can be determined.

To establish a three-dimensional model, at least three images are necessary, which include substantially the same features, but were recorded from different recording poses.

As soon as a model has been established, it can be improved by further recordings. The method according to the invention of the local transformation can also be used herefor. FIG. 7 shows a line L, which is already present in a three-dimensional model and was identified in the images a and b as the lines 11 and 12.

To find the line L in a new image c, it is now possible on the basis of the recording pose of the image c to project a transformed image 13 of the line L into the image c. Here, a region s around the line 13 can be used, which delimits the search space in which a line 13 can then be found by way of edge or line detection.

### LIST OF REFERENCE SIGNS

1 site measuring device
2 housing
3 screen
4 handles
5 fisheye lens
6 image sensor
7 trigger
8 optical axis
9 incident light ray
10 curve for perspective mapping
11 curve for ideal equidistant mapping
12 curve for real equidistant mapping
13 curve for mapping according to the invention
r radius with respect to the optical axis
ϕ angular aperture of the lens
θ angle of incidence with respect to the optical axis

1. A site measuring device (1), comprising:
an image capturing device with a lens (5);
a planar image sensor (6) for capturing an image of the lens (5);
an image processor configured to ascertain a geometric measurement value; and
the lens (5) has a non-gnomonic mapping function.

2. The site measuring device (1) as claimed in claim 1, wherein the lens (5) defines at least one of a projection center, the lens (5) is a fisheye lens, or the lens (5) has an equidistant mapping function.

3. The site measuring device (1) as claimed in claim 2, wherein the lens (5) has a mapping function that at least one of defines a linear dependence between an angle θ and a radius r or is describable by a polynomial distortion model.

4. The site measuring device (1) as claimed in claim 1, wherein the lens (5) is embodied to more strongly distort in a periphery region.

5. The site measuring device (1) as claimed in claim 1, wherein the lens (5) has a mapping function that has at least one non-linear dependence of an angle θ.

6. The site measuring device (1) as claimed in claim 1, wherein the lens (5) has a mapping function that has at least one additional polynomial element of a higher degree.

7. The site measuring device (1) as claimed in claim 1, wherein an angle of view (ϕ) of the lens (5) is greater than 90°.

8. The site measuring device (1) as claimed in claim 1, wherein a mapping function of the lens is ascertainable by calibration with a reference object.

9. The site measuring device (1) as claimed in claim 1, wherein a mapping function of the lens storable, or stored, in the image processor.

10. The site measuring device (1) as claimed in claim 1, wherein the image processor is configured with a feature finder for detecting at least one of detecting point or edge features in the recorded images, and the feature finder, for edge detection, is configured to approximate lines, which have been detected in the recorded images and transformed with the mapping function, to a straight lines.

11. The site measuring device (1) as claimed in claim 1, wherein the image processor is configured with a feature finder for detecting point and/or edge features in the recorded images, wherein the feature finder, for edge detection in a recorded image, uses edges, which have been transformed with the mapping function.

12. The site measuring device (1) as claimed in claim 1, wherein the image capturing device and the image processor are in each case or together integrated in a portable device.

13. The site measuring device (1) as claimed in claim 1, wherein image capturing device is configured to transfer image data to the image processor.

14. The site measuring device (1) as claimed in claim 1, wherein the image sensor (6) is arranged perpendicularly to an optical axis (8) of the lens (5).

15. A method for measuring a geometric variable with a site measuring device having an image capturing device with a lens that has a non-gnomonic mapping function, a planar image sensor for capturing an image of the lens, and an image processor configured to establish a three-dimensional model from a plurality of recorded images, the method comprising:
in an image recording step, recording a plurality of non-perspective images of an object with the image recording device,
in an edge detection step, detecting lines in the recorded images and transforming said lines with a mapping function of the lens, and registering the lines which can be approximated as a straight line as an edge feature,
in a modelling step, calculating a three-dimensional model from the lines which are assigned to the registered edge features, and
determining a geometric variable in the three-dimensional model.

16. The method as claimed in claim 15, further comprising, in a calibration step, determining the mapping function of the lens, calculating a model from a plurality of images of a reference object and, from the deviations of the model with respect to a reference model, determining the mapping function.

17. The method as claimed in claim 15, further comprising, in a bundle adjustment step, performing not only the actual bundle adjustment but also optimization of camera parameters.
